(19) United States
(12) Patent Application Publication
(10) Pub. No.: US 2006/0220323 A1
(43) Pub. Date: Oct. 5, 2006

(54) Static flexible seal

(76) Inventors: Lewis A. Frostick, Clinton Township, MI (US); David J. Hickson, Wheatley (CA); William F. Miller III, Beverly Hills, MI (US)

Correspondence Address: GENERAL MOTORS CORPORATION;LEGAL STAFF, MAIL CODE 482-C23-B21, P O BOX 300, DETROIT, MI, 48265-3000, US

(21) Appl. No.: 11/150,595

(22) Filed: Jun. 10, 2005

Related U.S. Application Data
(60) Provisional application No. 60/667,315, filed on Mar. 31, 2005.

(51) Int. Cl. F16J 15/00

(52) U.S. Cl. 277/500

(57) ABSTRACT

The present invention provides a seal having a generally annular elastomeric body having an S-shaped cross-section that includes a first portion, a second portion and an intermediate portion connecting the first and second portions. A first ring is disposed in the first portion and a second ring disposed in said second portion.

### CROSS-REFERENCE TO RELATED APPLICATIONS

This application claims the benefit of U.S. Provisional Application No. 60/667,315, filed on Apr. 1, 2005. The disclosure of the above application is incorporated herein by reference.

### FIELD OF THE INVENTION

The present invention relates to seals, and more specifically to static flexible seals.

### BACKGROUND OF THE INVENTION

Seals have been used to prevent ingress of contaminants and egress of fluids, such as lubricants, for years. The seals are typically comprised of an elastomeric material. Specifically, radial seals have been provided that have a relatively stiff outer surface as the result of the use of a rigid annular insert to provide engagement with a wall of an exterior structure. Typically, these seals have an inner engagement portion that is comprised of an elastomer that is stiff enough to provide sealing engagement with a part, such as an oil control valve. However, these elastomers are often required to be quite stiff in order to provide the proper sealing force. This results in a relatively high force needed to install these parts. More specifically, when a part must be installed in an assembly, variation may result in a stack-up condition that reduces tolerances and may not allow the part to be successfully installed due to misalignment of bore apertures within the assembly. This problem is compounded by the use of a relatively rigid elastomeric seal, since the part has little ability to move within the seal. It would therefore be beneficial to have an elastomeric seal that is substantially flexible to allow lower insertion forces and to accommodate tolerance stack-up issues while still providing the required sealing forces.

### SUMMARY OF THE INVENTION

The present invention provides a seal having a generally annular elastomeric body with an S-shaped cross-section including a first portion, a second portion and an intermediate portion connecting the first and second portions. A first ring is disposed in the first portion and a second ring disposed in the second portion.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a sectional view of a head, a front cover and a seal housing a valve; and

FIG. 2 is an enlarged sectional view of the seal of FIG. 1.

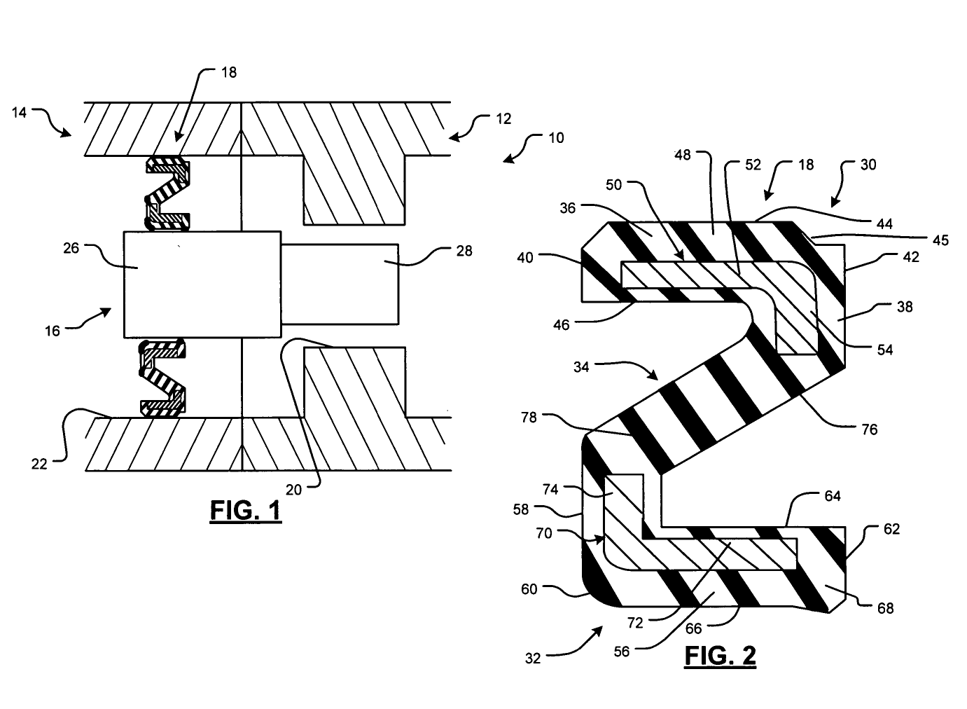

### DETAILED DESCRIPTION OF THE PREFERRED EMBODIMENTS

The following description of the preferred embodiments is merely exemplary in nature and is in no way intended to limit the invention, its application, or uses.

With reference to the drawings, a portion of an exemplary internal combustion engine 10 is shown in accordance with the teachings of the present invention. The internal combustion engine 10 includes a head 12, a front cover 14, a valve 16 and a seal 18. The head 12 and front cover 14 are fixedly attached to one another. The head 12 includes an aperture 20 that is generally aligned with an aperture 22 in the front cover 14.

The valve 16 has a first portion 26 and a second portion 28. The first and second portions 26, 28 have substantially cylindrical bodies. The first portion 26 is primarily disposed within the front cover 14 and the second portion 28 is primarily disposed within the head 12. The seal 18 provides sealing engagement between the first portion 26 of the valve 16 and the front cover 14. In the present example, the valve 16 is an oil control valve for a cam phaser. Here, the seal 18 prevents oil from escaping outside of the front cover 14. While the present invention is used as a seal 18 for a valve in the present example, it should be understood that the seal 18 could be used for providing sealing between a variety of static structures.

The seal 18 is generally annular in shape and includes a first portion 30, a second portion 32 and an intermediate portion 34. The seal 18 is comprised of an elastomeric material, such as polyacrylate. The seal 18 may also include a Teflon coating to provide further ease of valve installation. Specifically, the outer surface 66, may have a teflon coating thereon.

The first portion 30 of the seal 18 has a generally annular body with a generally L-shaped cross-section. The first portion 30 includes a body portion 36 and a leg portion 38 extending therefrom. The body portion 36 includes a trapezoidal portion 48 extending generally outwardly therefrom and a lead-in chamfer 45 proximate the trapezoidal portion 48. The body portion 36 further includes a first end 40, a second end 42, an outer surface 44 and an inner surface 46. The outer surface 44 extends along the trapezoidal portion 48. The outer surface 44 seals against the front cover 14. The leg portion 38 has a generally rectangular cross-section and extends generally perpendicularly from the inner surface 46 proximate the second end 42.

A first retaining ring 50 is located in the first portion 30. The ring 50 may be completely encapsulated within the first portion 30, as shown, or may have an exposed portion. As shown in FIG. 2, the ring 50 is completely encapsulated within the first portion 30, providing for corrosion avoidance. The ring 50 is comprised of a rigid material, such as steel, and provides a retention force between the first portion 30 and the front cover 14. The ring 50 has a generally L-shaped cross-section having a first leg portion 52 extending generally parallel to the aperture 22 in the front cover 14 and a second leg portion 54 extending generally perpendicular thereto. The first leg portion 52 of the first retaining ring 50 is generally disposed within the body portion 36. The second leg portion 54 of the first retaining ring 50 is generally disposed within the leg portion 38.

The second portion 32 of the seal 18 has a generally annular body with a generally L-shaped cross-section. The second portion 32 includes a body portion 56 and a leg portion 58 extending therefrom. The body portion 56 includes a first end 60, a second end 62, an inner surface 64 and a outer surface 66. The outer surface 66 has a protrusion 68 proximate the second end 62 generally extending therefrom, providing a sealing lip. The protrusion 68 seats against the first portion 26 of the valve 16, providing a sealing engagement therewith. The leg portion 58 has a generally rectangular cross-section and extends generally perpendicularly from the upper surface 64 proximate the first end 60.

A second retaining ring 70 is located in the second portion 32. The ring 70 may be completely encapsulated within the second portion 32, as shown, or may be partially exposed. As shown in FIG. 2, the ring 70 is completely encapsulated within the second portion 32, providing for corrosion avoidance. The ring 70 is comprised of a rigid material, such as steel, and provides a sealing force between the second portion 32 and the valve 16. The ring 70 has a generally L-shaped cross-section having a first leg portion 72 extending generally parallel to the first portion 26 of the valve 16 and a second leg portion 74 extending generally perpendicular thereto. The first leg portion 72 of the second retaining ring 70 is generally disposed within the body portion 56. The second leg portion 74 of the second retaining ring 70 is generally disposed within the leg portion 58.

The intermediate portion 34 extends between the first portion 30 and the second portion 32 and has a generally rectangular cross-section. A first end 76 of the intermediate portion 34 extends from the leg portion 38 of the first portion 30. A second end 78 of the intermediate portion 34 extends from the leg portion 58 of the second portion 32. The intermediate portion 34 is therefore disposed at an angle relative to the front cover aperture 22 and the valve 16.

The first retaining ring 50 provides forcible engagement between the first portion 30 of the seal 18 and the aperture 22 in the front cover 14. The second retaining ring 70 provides forcible engagement between the second portion 32 of the seal 18 and the first portion 26 of the valve 16. Since the valve 16 is contained in both the head 12 and the front cover 14, misalignment between the apertures 20, 22 in each necessitates some flexing of the seal 18. The intermediate portion 34 is able to flex, compensating for an offset between the centers of the aperture 22 in the front cover 14 and the aperture 20 in the head 12, while the first and second seal portions 30, 32 provide sealing and retention between the valve 16 and the front cover 14.

The description of the invention is merely exemplary in nature and, thus, variations that do not depart from the gist of the invention are intended to be within the scope of the invention. Such variations are not to be regarded as a departure from the spirit and scope of the invention.

1. A seal comprising:
a generally annular elastomeric body having a generally S-shaped cross-section including a first portion, a second portion and an intermediate portion connecting said first and second portions;
a first ring disposed in said first portion; and
a second ring disposed in said second portion.

2. The seal of claim 1, wherein said first portion is disposed radially outwardly from said second portion.

3. The seal of claim 2, wherein at least one of said first portion and said second portion has a generally L-shaped cross-section.

4. The seal of claim 3, wherein said first portion has a generally L-shaped cross-section having a first leg and a second leg, said first leg being generally axially oriented and said second leg extending radially inwardly from said first leg.

5. The seal of claim 3, wherein said second portion has a generally L-shaped cross-section having a first leg and a second leg, said first leg being generally axially oriented and said second leg extending radially outwardly from said first leg.

6. (canceled)

7. The seal of claim 1, wherein said second portion has a protrusion extending radially inwardly therefrom configured to sealingly engage a structure.

8. The seal of claim 1, wherein at least one of said first ring and said second ring has a generally L-shaped cross-section.

9. The seal of claim 1, wherein at least one of said first ring and said second ring are comprised of a substantially rigid material.

10. The seal of claim 9, wherein said substantially rigid material is steel.

11. The seal of claim 1, wherein said elastomeric material is polyacrylate.

12. The seal of claim 1, wherein said elastomeric body includes a polytetrafluoroethylene coating on at least a portion of an inner sealing surface thereof.

13. A seal comprising:
a generally annular elastomeric body having a generally S-shaped cross-section including a first portion, a second portion and an intermediate portion connecting said first and second portions, said first and second portions being substantially more rigid than said intermediate portion.

14. The seal of claim 13, wherein said intermediate portion is fixed to said first and second portions.

15. The seal of claim 13, wherein said first portion includes an elastomeric radially outer surface and said second portion includes an elastomeric radially inner surface, said first portion disposed radially outwardly from said second portion.

16. The seal of claim 15, wherein said first portion includes a first ring disposed therein and said second portion includes a second ring disposed therein.

17. The seal of claim 16, wherein said first and second rings are completely encapsulated within said elastomeric body.

18. The seal of claim 13, wherein said first, second, and intermediate portions form a unitary body.

19. The seal of claim 1, wherein said intermediate portion is fixed to said first and second portions.

20. The seal of claim 1, wherein said first and second rings are completely encapsulated within said elastomeric body.

21. The seal of claim 1, wherein said first, second, and intermediate portions form a unitary body.
